(19) United States
(12) Patent Application Publication
(10) Pub. No.: US 2008/0213019 A1
(43) Pub. Date: Sep. 4, 2008

(54) Process for Producing Rfid Labels

(76) Inventors: Thomas Walther, Hofheim (DE); Reinhard Baumann, Krailling (DE); Robert Weiss, Gersthofen (DE); Peer Dilling, Friedberg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 10/589,214

(22) PCT Filed: Jan. 28, 2005
(86) PCT No.: PCT/EP05/00850

§ 371 Date: Nov. 28, 2006

(30) Foreign Application Priority Data
Feb. 13, 2004 (EP) 10 2004 007 458.5

(51) Int. Cl. B41J 11/44

(52) U.S. Cl. 400/76

(57) ABSTRACT

The invention relates to a method for producing an RFID label using a printing method. The aim of the invention is to apply the required parts to the label in a simple manner, and preferably also to protect the antenna from mechanical damage. To this end, at least part of the antenna required for the operation of the label and part of the oscillating circuit is applied to the stock by means of sheet-fed offset printing or directly or indirectly by means of a relief-printing plate. In order to protect the oscillating circuit from damage, the application surface thereof is lowered, or the oscillating circuit and the antenna are lowered into the stock after the application process.

### CROSS-REFERENCE TO RELATED APPLICATIONS

This is a U.S. national stage of application No. PCT/EP2005/000850, filed on Jan. 28, 2005. Priority is claimed on the following application(s): Country: Germany, Application No.: 10 2004 007 458.5, Filed: Feb. 13, 2004; the content of which is incorporated herein by reference.

### BACKGROUND OF THE INVENTION

The invention pertains to a process for producing RFID labels.

The invention describes various processes for producing RFID (Radio Frequency Identification) labels, also called “smart labels”. The basis of intelligent labels (RFIDs, smart labels) is so-called transponder technology. Its great advantage lies in the wireless link between the label and the reader. This can greatly accelerate the mechanical process of data acquisition, because the reader no longer needs to be linked optically with the label. Thus, for example, the content of a box or of a whole pallet can be acquired without error. Security codes can also be stored in the smart labels, as a result of which packages cannot be falsified (e.g., pharmaceutical industry), and thefts can be clearly identified.

A system for wireless identification consists of two components: the RFID label (smart label), which is attached to the merchandise, and the read/write device, which can be used to read data from or to transfer data to the label. Depending on their design, the transponders store data ranging from simple identification numbers to complex sets of data (e.g., expiration date, production site and date, sale prices, etc.). Measurement data can also be stored. A transponder usually consists of an integrated circuit, an antenna, and other passive components. Depending on the way in which power is supplied, a distinction is made between active and passive transponders. If the label has its own power supply in the form of, for example, a battery, we speak of an active system. If the transponder is supplied with power by means of an external magnetic or electric field, the system is considered passive.

The transponder integrated circuit (IC), which is connected to the antenna of the mobile data storage medium, handles the transmission and reception of the data. In the case of passive RFID transponders, all of the intelligence and functionality are usually integrated in this circuit.

Some types also contain an on-chip resonance capacitor for an oscillating circuit, so that no other external components are required except for an antenna coil. The capacitor or capacitors required can also be produced by printing methods. Known, standard processes for the production of RFID labels include the lamination of a coated foil onto the label, the printing of the antenna by the screen printing method, and production by means of ink-jet printing.

Merchandise security labels, such as the RFID labels described above, can be applied directly to the merchandise, to its packaging, or to the external packaging for the shipment of the merchandise. Accordingly, they are almost always located on the outside of a package and can be damaged by mechanical stress. This damage is to be prevented to the greatest extent possible, both during production and subsequent transport of the product.

### SUMMARY OF THE INVENTION

The object of the present invention is to apply the required parts to a label in a simple way and preferably also to protect the chip and, if possible, the antenna from mechanical damage.

According to a preferred embodiment of the present invention, the process for producing an RFID label having an antenna and an oscillating circuit by using a printing process comprises the steps of providing a printable substrate, and applying at least part of at least one of the antenna and the oscillating circuit to the substrate by sheet-fed offset printing.

According to another preferred embodiment of the present invention, the process for producing an RFID label having an antenna and an oscillating circuit by using a printing process comprises the steps of providing a printable substrate, and applying at least part of at least one of the antenna and the oscillating circuit directly or indirectly to the substrate by means of a letterpress plate.

Elaborations of the invention can be derived from the various dependent claims.

### BRIEF DESCRIPTION OF THE DRAWINGS

FIG. 1 is a schematic top view of an RFID antenna and part of an oscillating circuit printed on a substrate by the process according to the invention;

FIG. 2 is a schematic top view of an RFID antenna printed by the process according to the invention with a recess introduced in the substrate; and

FIG. 3 is a schematic cross sectional view of the RFID antenna and a chip in the recess of FIG. 2.

### DETAILED DESCRIPTION OF PRESENTLY PREFERRED EMBODIMENTS

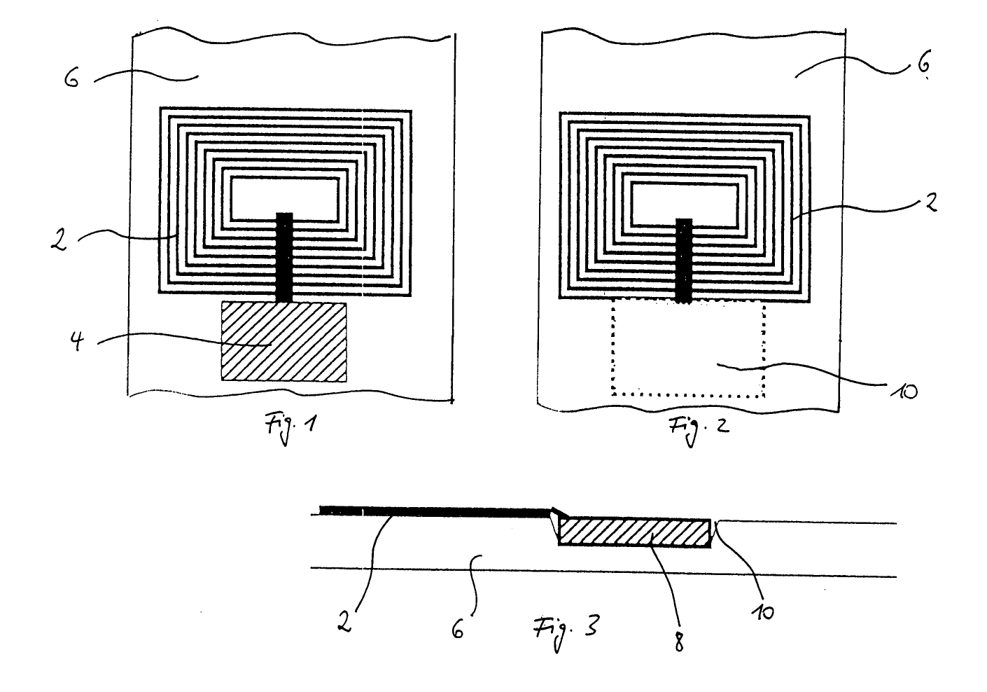

As can be seen from FIG. 1, the antenna 2 and part of the oscillating circuit 4 which are required for the proper functioning of an RFID label are applied to the substrate 6. According to the invention, this can be done by offset printing, or directly or indirectly by means of a letterpress plate. After printing, the only further step required is to attach the chip 8 (see FIG. 3), which usually does not have a housing, by means of a bonding or soldering process. Therefore, it is especially advantageous if the area in which the chip 8 is to be attached is lowered by a shaping operation after printing and before the application of the chip 8. This makes it possible to realize lowering of the chip 8 as well as a guide function during the application. It is also possible to lower the entire area of the label afterwards.

With respect to the design of the antenna, the following parameters are of interest: the inductance, the coil area, the ohmic (active) resistance, and the mutual capacitance between the windings. Deviations from the characteristic values can make it impossible for contact to be established between the read/write device and the transponder. The resonance frequency must also be achieved with a high level of accuracy, which means that very strict standards are imposed on the quality of the printing.

According to a preferred embodiment of the invention, a metal ink or conductive paste is transferred via a waterless offset plate or a wet offset plate and via the printing blanket to the substrate 6 within a sheet-fed or rotary web offset press. The printed lines form the antenna 2 and possibly the entire oscillating circuit 4. The chip 8 is then soldered or glued on later, if necessary. The substrate 6, on which the components of the antenna and/or the oscillating circuit 4 are printed, can be a fibrous material (paper, nonwoven, etc.), a fabric of natural or synthetic fibers, or a plastic film.

An absorbent substrate 6, e.g., paper or some other fibrous material, can be pretreated to prevent the conductive ink or paste from being absorbed. The pretreatment can involve pre-inking or the application of printer's varnish by means of a flexo press or an offset press. It is also possible to laminate a film onto the back of the label or to have the back of the label pretreated by the manufacturer. If a large amount of ink is absorbed by the substrate 6, the inductance can change as a result of the third plane. Application by means of a plate for waterless printing is preferred over wet offset, because the wetting agent required for wet offset printing can lead to corrosion of the ink. The precision of the printing is also higher. Waterless offset also makes it possible to obtain higher resolutions and finer lines.

The capacitor required to produce the oscillating circuit 4 can be obtained by printing two lines closely together, which are connected to each other at the ends of the shorter line. Alternatively, the base line can be printed first; an insulating material is printed on top of it; and then the opposing line is printed on top of that in a third printing couple. The capacitor can also be integrated into the chip 8. Other circuit elements such as resistors can also be printed by tapering the thickness of the lines.

In theory, the capacitor lines can be printed on both sides of the substrate 6 so that they are opposite each other. For this purpose, it is also necessary to perforate the substrate 6 beforehand so that a connection is established between the two opposing lines when the ink is applied.

Finally, the antenna 2 and the oscillating circuit 4 can be coated with a protective coating, which protects the printed image against mechanical, chemical, and oxidative damage. Alternatively, a protective film can be applied over them.

According to another preferred embodiment of the process, an adhesive is preprinted by passing it through a printing couple. The sheet printed with the adhesive is then brought into contact with a transfer film, which has been coated with a metallic or other conductive material. At the points where the adhesive has been applied, the conductive material is separated from the carrier film and transferred to the substrate. This then forms the oscillating circuit 4, antenna 2, or certain parts of these components.

According to another preferred embodiment of the process, the lines of the antenna 2 and/or of the oscillating circuit 4 can be printed by means of a flexo press. The disadvantage of this, however, is that a flexo plate can lead to blurred edges if it is not positioned precisely. These blurred edges would change the capacitance and thus cause a change in the characteristics of the oscillating circuit 4.

To be able to label the merchandise with an RFID label, on the one hand, and to protect the RFID label from damage, on the other hand, the following process is proposed:

1. The antenna 2 and possibly components of the oscillating circuit 4 are applied by one of the specified printing methods, as described above (FIG. 1). This can be accomplished by offset printing, or by direct or indirect letterpress printing on a deformable substrate 6.

2. A recess 10, a groove, or an impression in the substrate 6 is then made in a stamping or grooving machine, which, in a preferred embodiment, is located within the printing press. The recess 10 (shown in FIG. 2) is intended for subsequently receiving a bar-shaped or rectangular or square chip 8. The forming can also be carried out in a separate stamping machine during the stamping-out operation or in the folder-gluer. The recess 10 should be sufficiently deep so that the surface of the chip 8 or of the component that contains the oscillating circuit 4 is flush with the surface of the substrate 6. It is also possible for the surface of the chip 8 to lie somewhat lower than the surface of the substrate 6.

3. After the recess 10 has been made, the chip 8 (FIG. 3) or oscillating circuit is applied and joined with the conductive track or the antenna 2 by a soldering or adhesive bonding process. The conductive track of the antenna 2 or of the oscillating circuit must be elastic or flexible to the extent that it undergoes deformation of the magnitude required for the production of the recess 10. In this connection, the surface of the substrate 6 will also bend in the vicinity of the antenna 2 or conductive track.

This process provides several advantages. An unprotected chip 8 or even a chip 8 enclosed in a protective covering is thus better protected from mechanical stress. Since packages containing RFID labels are placed directly side by side in their shipping containers or on warehouse shelves, they can rub against each other. This poses the risk of mechanical damage of the oscillating circuits 4 or chips 8 and antennas 2. The recessed arrangement protects the oscillating circuit 4 or chip 8 and antenna 2 from this type of mechanical damage. Another advantage of the recess 10 is that it provides a positioning aid during the mounting of the chip 8.

Alternatively, the entire oscillating circuit 4, including the chip 8, can be applied to the substrate 6. In an additional step of the process, the entire RFID label can then be sunk by a stamp in such a way that the RFID label can no longer be damaged by mechanical influences or rubbing.

1.-32. (canceled)

33. A process for producing an RFID label having an antenna and an oscillating circuit by using a printing process, comprising:
providing a printable substrate; and
applying at least part of at least one of the antenna and the oscillating circuit to the substrate using sheet-fed offset printing.

34. The process of claim 33, wherein said step of applying further comprises using a conductive paste or conductive ink to print conducting tracks as part of at least one of the antenna and the oscillating circuit.

35. The process of claim 34, wherein the conductive ink is used and the conductive ink is an ink with metal particles.

36. The process of claim 34, wherein the conductive paste is used and the conductive paste contains carbon black or carbon fibers.

37. The process of claim 34, wherein said step of applying comprises applying the conductive paste or the conductive ink in a sheet-fed offset press with gripper transport.

38. The process of claim 34, wherein said step of applying comprises applying the conductive paste or the conductive ink in a rotary web offset press.

39. The process of claim 37, wherein said step of applying includes applying part of at least one of the antenna and the oscillating circuit to a rear surface of the substrate which is formed as a sheet, and flipping over the sheet in a turning device.

40. The process of claim 33, further comprising the step of applying a protective varnish or protective ink to the substrate after part of at least one of the antenna and the oscillating circuit has been printed.

41. The process of claim 40, wherein said step of applying a protective varnish or protective ink comprises transferring the protective varnish or protective ink to the substrate in a sheet-fed offset press.

42. The process of claim 40, wherein said step of applying a protective varnish or protective ink comprises transferring the protective varnish to the substrate in a flexo press with an ink chamber blade and a screen roller.

43. The process of claim 40, wherein said step of applying a protective varnish or protective ink comprises applying the protective varnish to the substrate in a flexo press with twin-roll capacity.

44. A process for producing an RFID label having an antenna and an oscillating circuit using a printing process, comprising:
providing a printable substrate; and
applying at least part of at least one of the antenna and the oscillating circuit directly or indirectly to the substrate by using a letterpress plate.

45. The process of claim 44, further comprising clamping the letterpress plate onto a plate cylinder of a sheet-fed press or web-fed press, and transferring ink indirectly by way of a blanket cylinder to the substrate.

46. The process of claim 44, wherein the letterpress plate arranged in a sheet-fed or web-fed press is in direct contact with the substrate.

47. The process of claim 46, wherein the letterpress plate is used in a press which also contains offset printing units.

48. The process of claim 33, wherein the substrate is a fibrous material.

49. The process of claim 33, wherein the substrate is a film.

50. The process of claim 33, wherein the substrate is a fabric of at least one of natural and synthetic fibers.

51. The process of claim 33, further comprising, in the case of a substrate having absorbent properties, precoating, prevarnishing, or preprinting the substrate with a varnish or a pre-inking medium to reduce the absorbent properties.

52. The process of claim 51, wherein the precoating, prevarnishing, or preprinting is effected by direct letterpress.

53. The process of claim 51, wherein the precoating, prevarnishing, or preprinting is effected by a letterpress plate, acting indirectly by way of a blanket cylinder.

54. The process of claim 51, wherein the precoating, prevarnishing, or preprinting is effected by a printing unit in an offset press.

55. The process of claim 33, wherein said step of applying further comprises the steps of printing two lines with different length next to each other over a certain portion of their length, and connecting the two lines to each other at ends of a shorter line of the two lines to produce a capacitive element.

56. The process of claim 33, wherein said step of applying further comprises the steps of printing a base line, printing an insulator over part of the base line, and printing an opposing line to produce a capacitive element.

57. The process of claim 44, wherein the substrate is a fibrous material.

58. The process of claim 44, wherein the substrate is a film.

59. The process of claim 44, wherein the substrate is a fabric of at least one of natural and synthetic fibers.

60. The process of claim 44, further comprising, in the case of a substrate having absorbent properties, precoating, prevarnishing, or preprinting the substrate with a varnish or a pre-inking medium to reduce the absorbent properties.

61. The process of claim 60, wherein the precoating, prevarnishing, or preprinting is effected by direct letterpress.

62. The process of claim 60, wherein the precoating, prevarnishing, or preprinting is effected by a letterpress plate, acting indirectly by way of a blanket cylinder.

63. The process of claim 60, wherein the precoating, prevarnishing, or preprinting is effected by a printing unit in an offset press.

64. The process of claim 44, wherein said step of applying further comprises the steps of printing two lines with different length next to each other over a certain portion of their length, and connecting the two lines to each other at ends of a shorter line of the two lines to produce a capacitive element.

65. The process of claim 44, wherein said step of applying further comprises the steps of printing a base line, printing an insulator over part of the base line, and printing an opposing line to produce a capacitive element.

66. The process of claim 33, further comprising the steps of forming a recess in the substrate, and placing a further part of the oscillating circuit or an integrated circuit (IC) chip in the recess such that the further part of the oscillating circuit or the IC chip is mounted therein and connected to the part of the at least one of the antenna and the oscillating circuit, thereby producing a conductive connection between the further part of the oscillating circuit or the IC chip and the antenna.

67. The process of claim 66, wherein the recess is formed sufficiently deep so that an upper surface of the further part of the oscillating circuit or the IC chip arranged parallel to an upper surface of the substrate is at least flush with the upper surface of the substrate after it has been placed in the recess.

68. The process of claim 66, wherein the recess is formed sufficiently deep so that an upper surface of the further part of the oscillating circuit or the IC chip arranged parallel to an upper surface of the antenna is at least flush with the upper surface of the antenna after it has been placed in the recess.

69. The process of claim 66, wherein said step of forming the recess includes stamping, impressing, or grooving the substrate.

70. The process of claims 66, wherein said step of forming the recess includes stamping, impressing, or grooving the substrate in one or more operating units within a printing press which is used for said step of applying.

71. The process of claim 66, wherein the substrate is a sheet and said step of forming the recess includes stamping, impressing, or grooving the substrate in a stamping press that produces one or more packaging cutouts from the substrate on which at least antennas and parts of oscillating circuits have been printed.

72. The process of claim 44, further comprising the steps of forming a recess in the substrate, and placing a further part of the oscillating circuit or an integrated circuit (IC) chip in the recess such that the further part of the oscillating circuit or the IC chip is mounted therein and connected to the part of the at least one of the antenna and the oscillating circuit, thereby producing a conductive connection between the further part of the oscillating circuit or the IC chip and the antenna.

73. The process of claim 72, wherein the recess is formed sufficiently deep so that an upper surface of the further part of the oscillating circuit or the IC chip arranged parallel to an upper surface of the substrate is at least flush with the upper surface of the substrate after it has been placed in the recess.

74. The process of claim 72, wherein the recess is formed sufficiently deep so that an upper surface of the further part of the oscillating circuit or the IC chip arranged parallel to an upper surface of the antenna is at least flush with the upper surface of the antenna after it has been placed in the recess.

75. The process of claim 72, wherein said step of forming the recess includes stamping, impressing, or grooving the substrate.

76. The process of claims 72, wherein said step of forming the recess includes stamping, impressing, or grooving the substrate in one or more operating units within a printing press which is for said step of applying.

77. The process of claim 72, wherein the substrate is a sheet and said step of forming the recess includes stamping, impressing, or grooving the substrate in a stamping press that produces one or more packaging cutouts from the substrate on which at least antennas and parts of oscillating circuits have been printed.

78. The process of claim 33, wherein said step of applying includes applying at least one of an antenna or part of an oscillating circuit to the substrate, applying one of the oscillating circuit, a further part of the oscillating circuit, or an integrated circuit (IC) chip to the substrate together with the antenna or the part of the oscillating circuit, producing a conductive connection between the oscillating circuit or IC chip and the antenna, and sinking the oscillating circuit or IC chip and the antenna at least to a level of a surface of the substrate by deformation of the substrate.

79. The process of claim 44, wherein said step of applying includes applying an antenna or part of an oscillating circuit to the substrate, applying one of the oscillating circuit, a further part of the oscillating circuit, or an integrated circuit (IC) chip to the substrate together with the antenna or the part of the oscillating circuit, producing a conductive connection between the oscillating circuit or IC chip and the antenna, and sinking the oscillating circuit or IC chip and the antenna at least to a level of a surface of the substrate by deformation of the substrate.

80. The process of claim 33, wherein the substrate is compressible.

81. The process of claim 44, wherein the substrate is compressible.
